(19) United States
(12) Patent Application Publication
(10) Pub. No.: US 2007/0202428 A1
(43) Pub. Date: Aug. 30, 2007

(54) COATED CARRIER PARTICLES AND PROCESSES FOR FORMING

(75) Inventors: Deepak R. Maniar, Webster, NY (US); Christopher M. Pattison, Rochester, NY (US); Thomas C. Dombroski, Rochester, NY (US); Brian Giannetto, Livonia, NY (US); Samir Kumar, Pittsford, NY (US); Eugene F. Young, Rochester, NY (US); Mark S. Jackson, Rochester, NY (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/276,435

(22) Filed: Feb. 28, 2006

(51) Int. Cl. G03G 9/113

(52) U.S. Cl. 430/111.35; 430/111.1; 430/111.41; 430/137.13

(57) ABSTRACT

Carrier core is coated with a coating containing polymer formed in the Presence of a surfactant and conductive particles coated with conductive polymer. The carrier may be formed by forming polymer particles by polymerization in the presence of a surfactant; dry-mixing carrier cores with a powder comprising the polymer particles and conductive particles coated with conductive polymer; and heating the mixture to fuse the powder to the surface of the cores.

### TECHNICAL FIELD

The present disclosure relates to carrier compositions and processes for forming carrier compositions, and more specifically, carrier compositions coated with polymer formed in the presence of a surfactant and conductive particles coated with conductive polymer. These coated carrier compositions may be used in xerographic processes and devices.

### RELATED APPLICATION

U.S. Published Patent Application No. 2005/0064194 describes carrier comprised of a core and a polymer coating, wherein the coating contains a conductive polypyrrole or polyaniline contained in a carbon black matrix. In embodiments, the polymer coating contains polymethylmethacrylate and EEONOMER™.

The appropriate components and process aspects of the foregoing may be selected for the present disclosure in embodiments thereof, and the entire disclosure of the above-mentioned patent application is totally incorporated herein by reference.

### REFERENCES

U.S. Pat. No. 4,935,326 discloses a carrier and developer composition, and a process for the preparation of carrier particles with substantially stable conductivity parameters which comprises (1) providing carrier cores and a polymer mixture; (2) dry mixing the cores and the polymer mixture; (3) heating the carrier core particles and polymer mixture, whereby the polymer mixture melts and fuses to the carrier core particles; and (4) thereafter cooling the resulting coated carrier particles. These particulate carriers for electrophotographic toners are described to be comprised of core particles with a coating thereover comprised of a fused film of a mixture of first and second polymers which are not in close proximity in the triboelectric series, the mixture being selected from the group consisting of polyvinylidenefluoride and polyethylene; polymethyl methacrylate and copolyethylene vinyl acetate; copolyvinylidenefluoride tetrafluoroethylene and polyethylenes; copolyvinylidenefluoride tetrafluoroethylene and copolyethylene vinyl acetate; and polymethyl methacrylate and polyvinylidenefluoride.

There is illustrated in U.S. Pat. No. 6,042,981 carriers including a polymer coating wherein the polymer coating may contain a conductive component, such as carbon black, and which conductive component, may be dispersed in the polymer coating. The conductive component is incorporated into the polymer coating of the carrier core by combining the carrier core, polymer coating, and the conductive component in a mixing process such as cascade roll mixing, tumbling, milling, shaking, electrostatic powder cloud spraying, fluidized bed, electrostatic disc processing or by an electrostatic curtain. After the mixing process, heating is initiated to coat the carrier core with the polymer coating and conductive component.

U.S. Pat. No. 6,355,391 describes a micro-powder that can be used as a coating for carrier core particles. The micro-powder includes a sub-micron sized powder recovered from a synthetic latex emulsion of polymer and surfactant, and a conductive filler incorporated into the powder. The patent indicates that, in embodiments, the polymer is a methyl methacrylate polymer or copolymer. The conductive filler may be any suitable material exhibiting conductivity, e.g., metal oxides, metals, carbon black, etc. The patent also discloses incorporating the micro-powder onto the surface of carrier, followed by heating.

There is illustrated in U.S. Pat. No. 6,764,799 carrier comprised of a core and thereover a polymer coating, the polymer coating being generated by the emulsion polymerization of one or more monomers and a surfactant. This patent specifically indicates that the coated carriers are substantially free of or free of conductive components like conductive carbon blacks.

The appropriate components and process aspects of the foregoing may be selected for the present disclosure in embodiments thereof, and the entire disclosure of the above-mentioned patents is totally incorporated herein by reference.

### BACKGROUND

The electrostatographic process, and particularly the xerographic process, is known. This process involves the formation of an electrostatic latent image on a photoreceptor, followed by development of the image with a developer, and subsequent transfer of the image to a suitable substrate. In xerography, the surface of an electrophotographic plate, drum, belt or the like (imaging member or photoreceptor) containing a photoconductive insulating layer on a conductive layer is first uniformly electrostatically charged. The imaging member is then exposed to a pattern of activating electromagnetic radiation, such as light. The radiation selectively dissipates the charge on the illuminated areas of the photoconductive insulating layer while leaving behind an electrostatic latent image on the non-illuminated areas. This electrostatic latent image may then be developed to form a visible image by depositing finely divided electroscopic marking particles on the surface of the photoconductive insulating layer. The resulting visible image may then be transferred from the imaging member directly or indirectly (such as by a transfer or other member) to a print substrate, such as transparency or paper. The imaging process may be repeated many times with reusable imaging members.

Numerous different types of xerographic imaging processes are known wherein, for example, insulative developer particles or conductive developer particles are selected depending on the development systems used. Moreover, of importance with respect to the aforementioned developer compositions is the appropriate triboelectric charging values associated therewith, as it is these values that enable continued formation of developed images of high quality and excellent resolution. In two component developer compositions, carrier particles are used in charging the toner particles.

Carrier particles in part comprise a roughly spherical core, often referred to as the “carrier core,” which may be made from a variety of materials. The core is often coated with a resin. This resin may be made from a polymer or copolymer. The resin may have conductive material or charge enhancing additives incorporated into it to provide the carrier particles with more desirable and consistent triboelectric properties. The resin may be in the form of a powder, which may be used to coat the carrier particle. Often the powder or resin is referred to as the “carrier coating” or “coating.”

Known methods of incorporating conductive material into carrier coating include the use of electrostatic attraction, mechanical impaction, in situ polymerization, dry-blending, thermal fusion and others. These methods of incorporating conductive material into carrier coatings often result in only minimal amounts of conductive material being incorporated into the coating or produces conductive carrier coatings too large for effective and efficient use in some of the smaller carriers. Other conductive coating resins use dry-blending processes and other mixing to incorporate the carbon black or other conductive material into the polymer.

However, in order to avoid transfer of carbon black from conductive polymers so obtained, the amount of carbon black that can be blended is severely limited, e.g., to 10% by weight or less. This in turn severely limits the conductivity achievable by the resultant conductive polymer.

In addition to the problems associated with loading conductive materials into coating resins, recent efforts to advance carrier particle science have focused on the attainment of coatings for carrier particles to improve development quality and provide particles that can be recycled and that do not adversely affect the imaging member in any substantial manner. Many of the present commercial coatings can deteriorate rapidly, especially when selected for a continuous xerographic process where the entire coating may separate from the carrier core in the form of chips or flakes causing failure upon impact or abrasive contact with machine parts and other carrier particles. These flakes or chips, which cannot generally be reclaimed from the developer mixture, have an adverse effect on the triboelectric charging characteristics of the carrier particles, thereby providing images with lower resolution in comparison to those compositions wherein the carrier coatings are retained on the surface of the core substrate.

Further, another problem encountered with some prior art carrier coatings resides in fluctuating triboelectric charging characteristics, particularly with changes in relative humidity. High relative humidity hinders image density in the xerographic process, may cause background deposits, leads to developer instability, and may result in an overall degeneration of print quality. In the science of xerography, the term “A Zone” is used to refer to hot and humid conditions, while the term “C Zone” is used to refer to cold and dry conditions. Triboelectric charges are usually lower in the “A Zone” than in the “C Zone.” It is desirable to have the measured triboelectric charges (_{tc}) for a particular carrier in the A Zone and the C Zone, when entered into a ratio of A zone_{tc}/C zone_{tc}, to be close to 1.0 in order to obtain good development in high humidity.

A carrier coating commonly used is #MP-116 PMMA available from Soken Chemical in Japan. This powder typically has a diameter of 0.4 to 0.5 micrometers and is a made from polymethyl methacrylate. However, it is required to use high amounts of #MP-116 PMMA to coat 30 to 150 micrometer carrier cores to achieve surface area coverage on the carrier of 85% to 95%. Use of such high amounts of carrier coating often results in lower carrier yields due to fused aggregates. Fused aggregates must be broken up or removed by screening. Crushing or breaking up of the aggregates may result in weak or “chipped off” areas on the carrier surface potentially causing poor coating quality. Screen separation may result in a lower yield as aggregates are removed from the final product.

Various coated carrier particles for use in electrostatographic developers are known in the art. Carrier particles for use in the development of electrostatic latent images are described in many patents including, for example U.S. Pat. No. 3,590,000. These carrier particles may comprise various cores, including steel, with a coating thereover of fluoro-polymers and ter-polymers of styrene, methacrylate, and silane compounds.

There is a continuing need to be able to incorporate high amounts of conductive material into coating resins while providing for and maintaining desirable xerographic qualities such as high coating efficiency, proper performance, and stable charging characteristics.

### SUMMARY

In embodiments, the present disclosure is directed to a method for forming carrier. In embodiments, the method comprises forming polymer particles by polymerization in the presence of a surfactant; dry-mixing carrier cores with a powder comprising the polymer particles and conductive particles coated with conductive polymer; and heating the mixture to fuse the powder to the surface of the cores. In embodiments, the polymer particles have an average particle size of less than about 100 nm, such as from about 50 to about 100 nm.

In embodiments, the present disclosure is directed to carrier comprising a core and a coating, the coating comprising a polymer formed in the presence of a surfactant and conductive particles coated with conductive polymer. In embodiments, the polymer formed in the presence of the surfactant contains an amount of the surfactant.

In embodiments, the coating is present on the cores in an amount of less than about 2 percent by weight of the core, such as in an amount of less than about 1 percent by weight of the core. In embodiments, the coating is present on the cores in an amount of less than 0.5 percent by weight of the core, such as in an amount of less than about 0.4 percent by weight of the core. In embodiments, the coating covers at least about 80% of the surface area of the cores, such as from about 85% to about 95% of the surface area of the cores.

### BRIEF DESCRIPTION OF THE DRAWINGS

Various exemplary embodiments of the disclosure will be described in detail, with reference to the following figures, wherein:

FIG. 1 shows a plot of halftone reproduction versus percent halftone input after 500 prints;

FIG. 2 shows a plot of halftone reproduction versus percent halftone input after 2500 prints; and

FIG. 3 shows the S-ness figure of merit for carriers of the present disclosure.

### EMBODIMENTS

In embodiments, the present disclosure is directed to carrier comprising a core and a coating, the coating comprising a polymer formed in the presence of a surfactant and conductive particles coated with conductive polymer. In embodiments, the core is conductive. For example, the core may comprise metal. In particular embodiments, the core comprises at least one of magnetite or ferrite.

In embodiments, the surfactant is an anionic surfactant. In embodiments, the surfactant is sodium lauryl sulfate.

In embodiments, the conductive particles that are in the coating of the carrier comprise carbon black. In embodiments, the conductive polymer that coats the conductive particles is at least one of polyaniline or polypyrrole. However, other conductive particles and/or conductive polymers may also be used.

In embodiments, the conductive polymer is formed by in situ polymerization of the conductive polymer in a matrix of the conductive particles.

In particular embodiments, the conductive particles coated with conductive polymer are the particles described in U.S. Pat. No. 6,132,645, which is herein incorporated by reference in its entirety. In embodiments, the coating composition is an electrically conductive polymeric composition as described in U.S. Pat. No. 5,498,372, which is herein incorporated by reference in its entirety. In particular embodiments, the conductive particles coated with conductive polymer are a product known as EEONOMER™, which can be obtained from Eeonyx Corporation. EEONOMER™ is an intrinsically conductive polymer (ICP) additive.

It is understood that EEONOMER™ is prepared by in-situ polymerization and deposition of intrinsically conductive polymers, such as polyaniline or polypyrrole, into a carbon black or other matrix. The polymerization involves a catalyzed, oxidative polymerization of the monomer onto, in particular, carbon black. The conductivity of the ICP is, for example, from about 10 to about 50, and more specifically, from about 10 to about 40 Siemens/cm measured, for example, utilizing a pressed pellet per ASTM F84 and D257.

In embodiments, the particle size median diameter of the conductive particles coated with conductive polymer is, for example, equal to or less than about 100 nanometers, such as from about 25 to about 75 nanometers, and/or have a particle size distribution wherein 99 percent of the particles are of a diameter of below about 100 nanometers, that is for example about 1 percent of the particles are as large as 300 nanometers.

The polymer formed in the presence of a surfactant is generally a polymer that will form a good coat on the carrier. This polymer need not be conductive. However, this polymer could be a conductive polymer and could, in fact, be the same polymer as the conductive polymer that is coated on the conductive particles. In embodiments, the coating comprises from about 3% to about 30% by weight conductive particles coated with conductive polymer and from about 70% to about 97% by weight polymer formed in the presence of a surfactant.

In some embodiments, the coating comprises from about 15% to about 30% by weight conductive particles coated with conductive polymer and from about 70% to about 85% by weight polymer formed in the presence of a surfactant. In these embodiments, in particular, carrier with a higher conductivity and in particular carrier having a higher conductivity in the coating than in the core can be obtained. As such, carrier that is more conductive than its core can be obtained.

In other embodiments, the coating comprises from about 3% to about 15% by weight conductive particles coated with conductive polymer and from about 85% to about 97% by weight polymer formed in the presence of a surfactant. In these embodiments, in particular, carrier with a higher breakdown voltage and better halftone reproduction can be obtained.

In embodiments, the polymer formed in the presence of a surfactant is an acrylic polymer. In embodiments, the acrylic polymer is polymethylmethacrylate (PMMA) polymer or copolymer. Suitable comonomers that may be used to form a PMMA copolymer include, for example, monoalkyl or dialkyl amines such as dimethylaminoethyl methacrylate, diethylaminoethyl methacrylate, diisopropylaminoethyl methacrylate, acrylic or methacrylic acids, or fluoroalkyl or perfluorinated acrylic and methacrylic esters, such as, for example fluoro-ethyl methacrylate, such as 2,2,2-trifluoro-ethyl methacrylate, or fluoro-ethylacrylate.

Forming the polymer, such as the polymethylmethacrylate polymer or copolymer, in the presence of a surfactant, such as sodium lauryl sulfate, may produce a polymer having an average particle size of less than 100 nm, such as from about 50 to about 100 nm. Using polymer particles having such an average particle size may provide better coverage, such as where at least about 80%, for example from about 85% to about 95%, of the core is covered by coating. In particular, using such polymer particles can provide better coverage without the application of a thick coating. For example, such coverage can be obtained even when the coating is present on the cores in an amount of less than about 2 percent by weight of the core, such as in an amount of less than about 1, less than about 0.5 or less than about 0.4 percent by weight of the core.

The coating may be adhered to the core by powder coating. In particular, conductive particles coated with conductive polymer can be mixed with polymer particles. The particle mixture can then be mixed with the carrier and heated to fuse the particles to the carrier core. However, the coating may be adhered to the core by other methods, such as solution coating, in situ polymerization and emulsion aggregation.

To form the polymer particles, the monomer or monomer mixture may be gradually mixed into an aqueous solution of surfactant such that only 5% to 30% of the total amount of monomer, is emulsified. Initiation of polymeric latex particles may be accomplished by rapid addition of a standard ammonium persulfate solution, followed by a metered addition of the remaining monomer supply. The metered rate may be from about 0.1 to about 5.0 grams per minute, such as about 1.5 grams per minute, for latex preparations of up to 350 grams. The mixing is generally continued after addition of the final amount of monomer. The temperature may be also maintained within a range of 60 to 70° C.

The mixing may be performed at a rate of, for example, about 50 to about 300 revolutions per minute for about 1 to 6 hours using any mechanical mixing apparatus known in the art. In embodiments, the dispersion is mixed at a rate of about 100-200 revolutions per minute for about 2 to 4 hours, with temperature between 65 to 67° C.

In embodiments, the surfactants are of the anionic type. Suitable surfactants include sodium lauryl sulfate (SLS), dodecylnapthalene sulfate, and others. In embodiments, no other surfactants of a different class or polarity are present.

The surfactant may be added in an amount of 0.2% to 5% by weight of the monomer polymerized. In an embodiment, the surfactant is SLS in the range of 0.4% to 0.8% by weight of the monomer to be polymerized. The initiator may be ammonium persulfate in a range of 0.2% to 1.0% by weight of the monomer. By procedures known to the art, surfactant concentration is used to regulate latex particle size, while initiator level is used to regulate the molecular weight of the polymer produced.

The recovery of the polymer particles from the emulsion suspension can be accomplished by processes known in the art. For example, the emulsion of polymer particles can first be filtered by any suitable material. In an embodiment, a cheese cloth is used. The polymer particles can then be washed, but in an embodiment, the polymer particles are not washed. Finally, the polymer particles are dried using, e.g., freeze drying, spray drying or vacuum techniques known in the art.

In embodiments, some amount of the surfactant is allowed to remain in association with the polymer particles. Allowing some amount of the surfactant to remain in association with the polymer particles may provide for better particle formation and better carrier coating characteristics. It is believed that the surfactants' interplay with the surface chemistry of the polymer particles provides for these improved results.

The polymer particles isolated from the process have an initial size of, for example, from about 0.01 micrometers to <1.0 micrometer. Due to physical aggregates, some of the polymer particles may initially be larger than 1.0 micrometer. During the mixing process with the conductive particles and/or the carrier cores, the physical aggregates of the polymer particles will be broken up into sub-micron polymer particles. In embodiments, the polymer particles obtained by the process herein have a size of, for example, from about 0.04 micrometers to about 0.250 micrometers, such as from about 0.08 micrometers to about 0.100 micrometers, that is, from 80 to 100 nm.

After the formation and recovery of the polymer particles, conductive particles coated with conductive polymer are incorporated with the polymer particles.

The coating of the present disclosure enables carriers to achieve a wide range of conductivity. Carriers using the coating of the present disclosure may exhibit conductivity of from about 10⁻⁵ to about 10⁻¹⁴ (ohm-cm)⁻¹. In embodiments, carriers using the coating of the present disclosure may exhibit conductivity of from about 10⁻⁵ to about 10⁻¹⁰ (ohm-cm)⁻¹.

The conductive particles coated with conductive polymer incorporated with the polymer particles in the process has a size of, for example, from about 0.012 micrometers to about 0.5 micrometers. In embodiments, these conductive particles have a size of, for example, from about 0.02 micrometers to about 0.05 micrometers.

The conductive particles coated with conductive polymer may be incorporated with the polymer particles using techniques known in the art including the use of various types of mixing and/or electrostatic attraction, mechanical impaction, dry-blending, thermal fusion and others.

In addition to incorporating conductive particles into carrier coatings, it is often desirable to impart varying charge characteristics to the carrier particle by incorporating charge enhancing additives. If incorporated with the polymer particles, the charge enhancing additives may be incorporated in a premixing process before or after the incorporation of the conductive particles.

Typical charge enhancing additives include particulate amine resins, such as melamine, and certain fluoro polymer powders such as alkyl-amino acrylates and methacrylates, polyamides, and fluorinated polymers, such as polyvinylidine fluoride (PVF₂) and poly(tetrafluoroethylene), and fluoroalkyl methacrylates such as 2,2,2-trifluoroethyl methacrylate.

Other charge enhancing additives such as, for example, those illustrated in U.S. Pat. No. 5,928,830, incorporated by reference herein, including quaternary ammonium salts, and more specifically, distearyl dimethyl ammonium methyl sulfate (DDAMS), bis-1-(3,5-disubstituted-2-hydroxy phenyl)axo-3-(mono-substituted)-2-naphthalenolato(2-) chromate(1-), ammonium sodium and hydrogen (TRH), cetyl pyridinium chloride(CPC), FANAL PINK® D4830, and the like and others as specifically illustrated therein may also be utilized in the present disclosure.

The charge additives may be added in various effective amounts, such as from about 0.5% to about 20% by weight, based on the sum of the weights of all polymer, conductive particles, and charge additive components.

After the synthesis of the coating particles, the coating may be incorporated onto the surface of the carrier. Various effective suitable processes can be selected to apply a coating to the surface of the carrier particles. Examples of typical processes for this purpose include roll mixing, tumbling, milling, shaking, electrostatic powder cloud spraying, fluidized bed, electrostatic disc processing, and an electrostatic curtain. See, for example, U.S. Pat. No. 6,042,981, incorporated herein by reference.

Following incorporation of the powder onto the surface of the carrier, heating may be initiated to permit flow of the coating material over the surface of the carrier core. In an embodiment, the coating materials are fused to the carrier core in either a rotary kiln or by passing through a heated extruder apparatus.

In an embodiment, the conductive polymer particles of the present disclosure are used to coat carrier cores of any known type by any known method, which carriers are then incorporated with any known toner to form a developer for xerographic printing. Suitable carrier cores may be found in, for example, U.S. Pat. Nos. 4,937,166 and 4,935,326, incorporated herein by reference, and may include granular zircon, granular silicon, glass, steel, nickel, ferrites, magnetites, iron ferrites, silicon dioxide, and the like.

Carrier cores having a diameter in a range of, for example, about 5 micrometers to about 100 micrometers may be used. In embodiments, the carriers are, for example, about 20 or about 30 micrometers to about 80 or about 70 micrometers.

Typically, the coating covers, for example, about 60% to about 100% of the surface area of the carrier core using about 0.1% to about 3.0% coating weight. In embodiments, about 75% to about 98% of the surface area is covered with the coating using about 0.3% to about 2.0% coating weight. In embodiments, surface area coverage is about 85% to about 95% using about 1% coating weight.

Use of smaller-sized coating powders has proven more advantageous as a smaller amount by weight of the coating is needed to sufficiently coat a carrier core. Using less coating is cost effective and results in less coating separating from the carrier to interfere with the tribolelectric charging characteristics of the toner and/or developer.

In embodiments, the present disclosure is directed to the coated carrier described herein with toner on the surface of the carrier. In further embodiments, the present disclosure is directed to a xerographic device comprising such a developer. In the xerographic device, the developer described herein may be used with any suitable imaging member to form and develop electrostatic latent images.

In embodiments, the carrier described herein provides a developer that, after developing 2500 prints, has an output L* plotted against input percent halftone having a correlation coefficient R² of from about 0.95 to 1.0, such as from about 0.96 to 1.0. In embodiments, the carrier has a log₁₀ detoned conductivity of about −5.8 (ohm-cm)⁻¹ or lower, such as about −7.0 (ohm-cm)⁻¹ or lower, before the developer is used to develop images. In embodiments, the carrier has a log₁₀ detoned conductivity from about −5.8 (ohm-cm)⁻¹ to about log₁₀ −7.5 (ohm-cm)⁻¹ before the developer is used to develop images. In embodiments, the developer has an S-ness Figure of Merit of about 3.5 or lower, such as about 2.5 or lower, before the developer is used to develop images.

### EXAMPLES

The following examples illustrate specific embodiments of the present disclosure. One skilled in the art would recognize that the appropriate reagents, component ratio/concentrations may be adjusted as necessary to achieve specific product characteristics. All parts and percentages are by weight unless otherwise indicated.

In the following examples, conductivity of the developer is a detoned developer conductivity. To measure the conductivity, toner is removed from the carrier and the conductivity is measured at 10 volts using the device described in U.S. Pat. No. 5,196,803. The breakdown voltage is measured using the same device. The tribo and toner concentration (TC) are measured according to the ASTM procedure F1425-92 at an air pressure of 55 pounds per square inch. Coating coverage was determined using scanning electron microscopy.

### Example 1

EEONOMER™ 200F, which is composed of carbon black that has been surface treated with a polypyrrole, was mixed in a blender with PMMA particles formed using sodium lauryl sulfate, which is referred to as SLS PMMA, at an EEONOMER™/PMMA ratio of 20% to 80% by weight. The resulting powder was powder coated onto a 65 μm magnetite core with a coating weight of 0.38%. To powder coat the cores, the powder mixture and the cores were blended together in a blender, followed by being processed in a rotary kiln at a temperature that enabled fusing of the coating mixture on the surface of the core material. By this technique, 87% of the surface of the cores was coated on average. The resulting carrier was mixed with toner in ajar mill and tested. The toner was Xerox 6R1046 (DC 555/545/535), which is a polyester-based toner. The conductivity of the resulting coated carrier was 8.74×10⁻⁷ (ohm-cm)⁻¹. The log of the conductivity was −6.06. The triboelectric charge on the carrier was 23.65 μC/g. The toner concentration (TC) was 3.75%. The breakdown voltage was 30.8 V.

### Example 2

EEONOMER™ 200F was mixed in a blender with SLS PMMA particles at an EEONOMER™/PMMA ratio of 5% to 95% by weight. The resulting powder was powder coated onto a 65 μm magnetite core with a coating weight of 0.18%. To powder coat the cores, the powder mixture and the cores were blended together in a blender, followed by being processed in a rotary kiln at a temperature that enabled fusing of the coating mixture on the surface of the core material. By this technique, 81% of the surface of the cores was coated on average. The resulting carrier was mixed with toner in ajar mill and tested. The toner was Xerox 6R1046. The conductivity of the resulting coated carrier was 1.51×10⁻¹¹ (ohm-cm)⁻¹. The log of the conductivity was −10.82. The triboelectric charge on the carrier was 24.5 μC/g. The TC was 4%. The breakdown voltage was 148.0 V. Although the conductivity of this example is not as high as in Example 1, the breakdown voltage is nearly five times higher.

### Comparative Example 1

A control carrier was also tested. This control carrier contains a 65 μm magnetite core solvent coated with a coating comprising PMMA and carbon black. The coating weight was approximately 2.1%. The carrier was mixed with toner in ajar mill and tested. The toner was Xerox 6R1046. The conductivity of the resulting coated carrier was 8.54×10⁻⁷ (ohm-cm)⁻¹. The log of the conductivity was −6.07. The triboelectric charge on the carrier was 23.3 μC/g. The TC was 3.81%. This carrier has similar properties as the carrier of Example 1. However, significantly thinner coating coverage was required in Example 1 to obtain these properties.

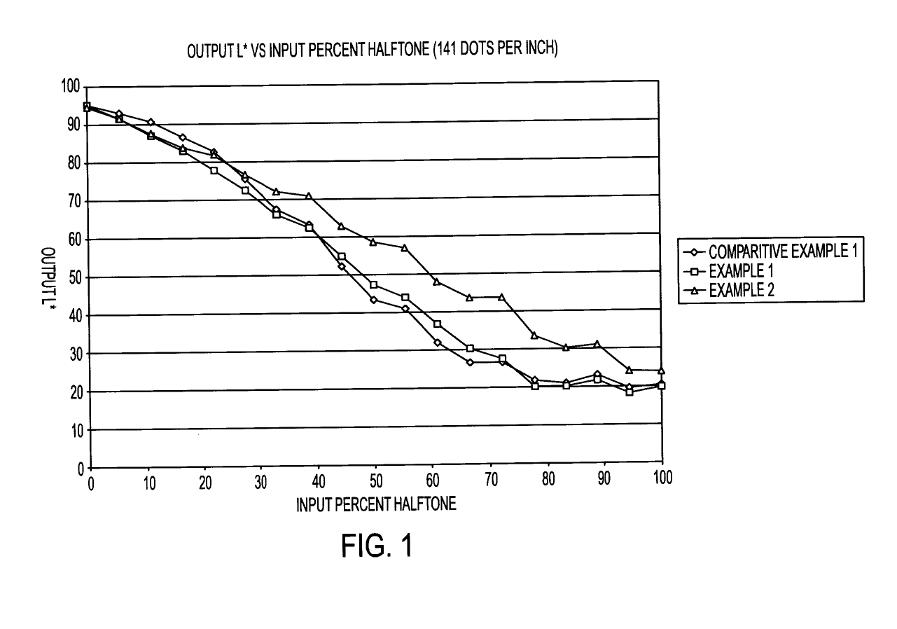

The developers of Examples 1 and 2 and Comparative Example 1 were also tested using a Xerox Work Centre 165 machine. The results of these tests are depicted in FIGS. 1-3.

FIG. 1 shows a plot of L* (L*˜1/10^{D/3}) of a halftone reproduction versus the percent halftone input after 500 prints. The curve with diamonds is the control carrier of Comparative Example 1. At both low and high percent halftone input the plot has a fair amount of curvature. This can be compared to the curve with squares, which is of the carrier of Example 1. Where the Example 1 curve is much like the Comparative Example 1 curve at high input percent halftone, there is a significant straightening of the curve at low percent halftone. In addition, the curve with triangles, which is of the carrier of Example 2, is significantly straighter than both of the other curves. As a result, the developer of Example 2 provides a better representation of the shading present in an image being copied or printed.

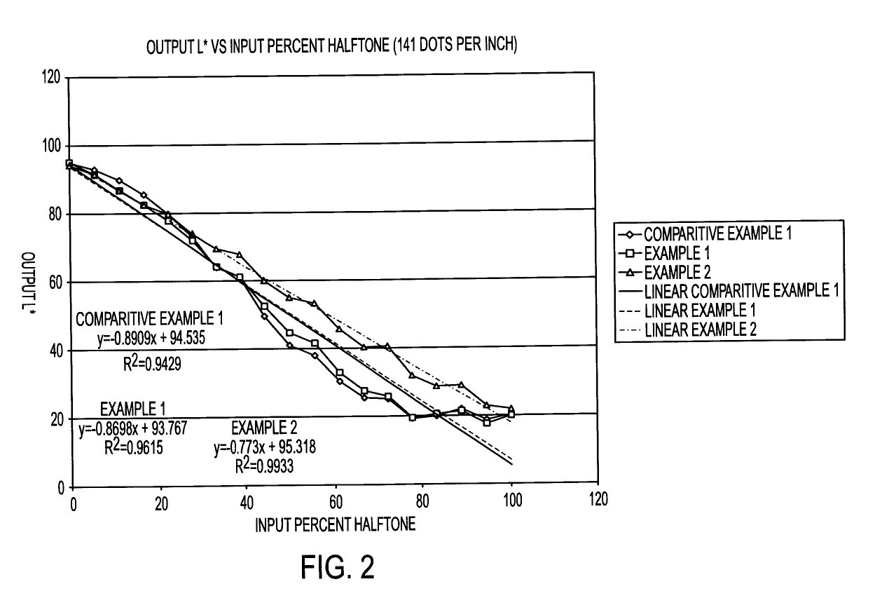

FIG. 2 demonstrates the same phenomenon for 2500 prints. A print is one cycle of the development process which results in an image fused to the paper or other media. Thus, 2500 prints would have created 2500 documents with an image of some sort on the paper. In FIG. 2, the regression lines are also included. Note that R² is significantly better for Example 2. The effect of these changes are more evident in the prints where it can be seen that for Example 2 there is an improvement in the definition of the highlights and in the shadow (dark) areas that show greater contrast differences. That is, it is possible to distinguish two shadow areas with greater clarity with the Example 2 carrier than with the Comparative Example 1.

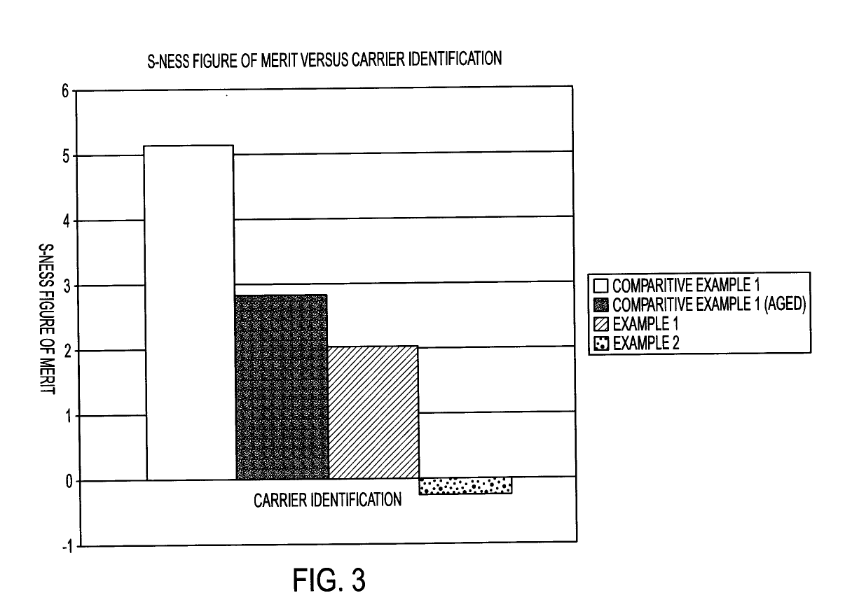

To further show the effect of changing the ratio of EEONOMER™ to SLS PMMA, an S-ness figure of merit is depicted in FIG. 3. In this table, S-ness=L* (at 20% input halfone)+0.4×(60−L*(at 50% halftone))−82. As depicted in the Figure, the S-ness for Comparative Example 1 is greater than 5, although after this Carrier has been aged by the formation of 2500 prints, it has a S-ness of 2.84. In Contrast, the carriers of both of Examples 1 and 2 have a S-ness of less than 2.5.

It will be appreciated that various of the above-disclosed and other features and functions, or alternatives thereof, may be desirably combined into many other different systems or application. Also, that various presently unforeseen or unanticipated alternatives, modifications, variations or improvements therein may be subsequently made by those skilled in the art which are also intended to be encompassed by the following claims.

What is claimed is:

1. Carrier comprising a core and a coating over the core, said coating comprising: (a) a polymer formed in the presence of a surfactant and (b) conductive particles coated with conductive polymer, wherein said coating over the core contains an amount of said surfactant.

2. Carrier according to claim 1, wherein said conductive particles comprise carbon black.

3. Carrier according to claim 1, wherein said conductive polymer is at least one of polyaniline or polypyrrole.

4. Carrier according to claim 1, wherein said conductive polymer is formed by in situ polymerization of the conductive polymer in a matrix of the conductive particles.

5. Carrier according to claim 1, wherein said polymer formed in the presence of a surfactant is an acrylic polymer.

6. Carrier according to claim 5, wherein said acrylic polymer is polymethyl methacrylate polymer or copolymer.

7. Carrier according to claim 1, wherein said surfactant is an anionic surfactant.

8. Carrier according to claim 1, wherein said surfactant is sodium lauryl sulfate.

9. Carrier according to claim 1, wherein the coating over the core is present in an amount of less than about two percent by weight of the core.

10. Carrier according to claim 1, wherein the coating covers at least about 80% of the surface area of the core.

11. A developer comprising toner and the carrier according to claim 1.

12. The developer according to claim 11, wherein, after developing 2500 prints using said developer, the developer has an output L* plotted against input percent halftone having a correlation coefficient R² of from about 0.95 to 1.0.

13. The developer according to claim 11, wherein the carrier has a log₁₀ detoned conductivity of about −5.8 (ohm-cm)⁻¹ or lower before the developer is used to develop images.

14. The developer according to claim 11, wherein said developer has an S-ness Figure of Merit of about 3.5 or lower before the developer is used to develop images.

15. A xerographic device comprising an image forming member and a housing containing a developer according to claim 11.

16. Carrier comprising a core and a coating over the core, said coating comprising: (a) a polymer formed in the presence of a surfactant and (b) conductive particles coated with conductive polymer, wherein the coating over the core is present in an amount of less than 0.5 percent by weight of the core and covers at least 80% of the surface area of the core.

17. Carrier according to claim 16, wherein said conductive polymer is formed by in situ polymerization of the conductive polymer in a matrix of the conductive particles.

18. Carrier according to claim 16, wherein said polymer formed in the presence of a surfactant is an acrylic polymer.

19. Carrier according to claim 18, wherein said acrylic polymer is polymethyl methacrylate polymer or copolymer.

20. A method for forming carrier, said method comprising:
(a) forming polymer particles by polymerization in the presence of a surfactant;
(b) dry-mixing carrier cores with a powder comprising the polymer particles and conductive particles coated with conductive polymer; and
(c) heating the mixture to fuse the powder to the surface of the cores.

21. The method according to claim 20, wherein said polymer particles have an average particle size of less than about 100 nm.

22. The method according to claim 20, wherein said conductive polymer is formed by in situ polymerization of the conductive polymer in a matrix of the conductive particles.

23. The method according to claim 20, wherein said polymer particles comprise an acrylic polymer.

24. The method according to claim 23, wherein said acrylic polymer is polymethyl methacrylate polymer or copolymer.

25. The method according to claim 20, wherein said surfactant is an anionic surfactant.

26. The method according to claim 20, wherein said surfactant is sodium lauryl sulfate.
